(19) United States
(12) Patent Application Publication
(10) Pub. No.: US 2012/0278563 A1
(43) Pub. Date: Nov. 1, 2012

(54) MEMORY DEVICE AND MEMORY SYSTEM

(75) Inventor: Young-hyun JUNG, Seoul (KR)

(73) Assignee: Samsung Electronics Co., Ltd, Suwon-si (KR)

(21) Appl. No.: 13/452,000

(22) Filed: Apr. 20, 2012

(30) Foreign Application Priority Data
Apr. 26, 2011 (KR) 10-2011-0039083

(51) Int. Cl. G06F 12/00

(52) U.S. Cl. 711/154; 711/E12.001

(57) ABSTRACT

A memory device having at least one memory including a first memory. The first memory includes a core area having a data storage unit that is non-volatile and a peripheral circuit area having an input/output circuit. The data storage unit of the first memory stores setting information about a memory controller corresponding to the first memory.

### CROSS-REFERENCE TO RELATED APPLICATIONS

This application claims priority under 35 U.S.C. §119(a) from Korean Patent Application No. 10-2011-0039083, filed on Apr. 26, 2011, in the Korean Intellectual Property Office, the disclosure of which is incorporated herein in its entirety by reference.

### BACKGROUND OF THE INVENTION

1. Field of the Invention

The present general inventive concept relates to a memory device and a memory system, and more particularly, to a memory device capable of accurately and efficiently performing an initialization operation between the memory device and a controller, and a memory system including the memory device.

2. Description of the Related Art

An initialization operation to set setting information such as a timing value is needed to interface between a memory device and a controller for controlling the memory device during system booting. However, since various types of memory devices and controllers have been introduced and new memory devices and new controllers have been incessantly developed, errors or delays may be generated in a setting operation between the memory device and the controller.

### SUMMARY OF THE INVENTION

The inventive concept provides a memory device that may accurately and efficiently perform an initialization operation between a memory device and a controller.

Additional features and utilities of the present general inventive concept will be set forth in part in the description which follows and, in part, will be obvious from the description, or may be learned by practice of the general inventive concept.

The present general inventive concept provides a memory system including a memory device that may accurately and efficiently perform an initialization operation between a memory device and a controller.

Exemplary embodiments of the present general inventive concept may provide a memory device having at least one memory. The memory device includes a first memory including a core area having a data storage unit that is non-volatile to store setting information about a memory controller corresponding to the first memory, and a peripheral circuit area having an input/output circuit.

The first memory may further include a register to set an operation characteristic.

The data storage unit of the first memory may further store setting information of the register of the first memory.

The memory device may further include a second memory that includes a core area having a data storage unit and a peripheral circuit area including an input/output circuit.

The data storage unit of the first memory may store setting information about a memory controller corresponding to the second memory.

The second memory may further include a register to set an operation characteristic.

The data storage unit of the first memory may further store setting information of the register of the second memory.

The memory device may be embodied by a multichip package (MCP).

The first memory may be a read only memory (ROM).

Exemplary embodiments of the present general inventive concept may also provide a memory system including a memory device having at least one memory and at least one memory controller having a register, the at least one memory controller to control a corresponding memory based on a setting state of the register. The memory device includes a first memory having a core area including a data storage unit that is non-volatile and a peripheral circuit area including an input/output circuit. The data storage unit of the first memory may store setting information about the register of a memory controller corresponding to the first memory.

The first memory may further include a first register to set an operation characteristic.

The data storage unit of the first memory may further store setting information of the register of the first memory.

The memory device may further include a second memory that includes a core area including a data storage unit and a peripheral circuit area including an input/output circuit.

The data storage unit of the first memory may store setting information about a memory controller corresponding to the second memory.

The second memory may further include a first register to set an operation characteristic.

The data storage unit of the first memory may further store setting information of the register of the second memory.

The first memory may further include a register to set an operation characteristic.

The data storage unit of the first memory may further store setting information of the register of the first memory.

The memory device may be embodied by a multichip package (MCP).

Exemplary embodiments of the present general inventive concept may also provide a memory system, including a memory device having a first memory having a core area having a data storage unit that is non-volatile to store setting information about a memory controller corresponding to the first memory, and a peripheral circuit area having an input/output circuit, and a memory controller communicatively coupled to the memory device to control at least one operation of the memory device.

The data storage unit of the memory system may include a first area to store setting information of the memory controller, the setting information to be transmitted to the memory controller during power-up of the memory system.

The memory controller of the memory system may include a first register to the setting information of the memory controller that is transmitted to the first area of the data storage unit.

The memory device of the memory system may further include a second register of the first memory to store an operation characteristic of the first memory.

The memory system may further include a second area of the data storage unit to store setting information of the second register.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 schematically illustrates a memory device according to exemplary embodiments of the present general inventive concept;

FIGS. 2-6 schematically illustrate memory devices according to exemplary embodiments of the present general inventive concept;

FIG. 7 schematically illustrates a memory system according to exemplary embodiments of the present general inventive concept;

FIGS. 8-12 schematically illustrate memory systems according to exemplary embodiments of the present general inventive concept;

FIG. 13 schematically illustrates a computer system according to exemplary embodiments of the present general inventive concept; and

FIG. 14 schematically illustrates a computer system according to exemplary embodiments of the present general inventive concept.

### DETAILED DESCRIPTION OF THE PREFERRED EMBODIMENTS

The attached drawings for illustrating preferred embodiments of the present general inventive concept are referred to in order to gain a sufficient understanding of the present general inventive concept, the merits thereof, and the objectives accomplished by the implementation of the present general inventive concept.

Hereinafter, the present general inventive concept will be described in detail by explaining preferred embodiments of the inventive concept with reference to the attached drawings. Like reference numerals in the drawings denote like elements.

FIG. 1 schematically illustrates a memory device 100 according to exemplary embodiments of the present general inventive concept. Referring to FIG. 1, the memory device 100 according to the present exemplary embodiments includes a first memory 110. The first memory 110 may be a variety of types of non-volatile memories. For example, the first memory 110 may be a read only memory (ROM), a flash memory, a phase-change random access memory (PRAM), etc. The first memory 110 includes a core area 120 and a peripheral circuit area 130. The core area 120 includes a data storage unit 122. The data storage unit 122 may include a plurality of cells (not illustrated) connected between a bit line (not illustrated) and a word line (not illustrated). The peripheral circuit area 130 may include an input/output circuit unit 132. The input/output circuit unit 132 may transmit data corresponding to an address (not illustrated) and a command (not illustrated) received from the outside, to the data storage unit 122, or may receive the data from the data storage unit 122.

When a system (not illustrated) is powered up, a controller (not illustrated) of the system and the memory device 100 included in the system together perform an operation to set setting information. For example, the setting information set in the memory device 100 and the controller may be timing information to control the communication between the memory device 100 and the controller. For example, the timing information may an operation time of the controller set according to CAS (column address strobe) latency and RAS (row access strobe) latency set with respect to the memory device 100.

The memory device 100 according to the at least the exemplary embodiments illustrated in FIG. 1 can store setting information about the controller in a first area 122_1 of the data storage unit 122 as illustrated in FIG. 1. The setting information stored in the first area 122_1 according to the exemplary embodiments of the present general inventive concept may be setting information corresponding to a plurality of controllers, and is not limited to setting information corresponding to a single controller, as described below in detail.

The first area 122_1 may be set to one or more sizes according to setting information to be stored. For example, the size (i.e., capacity) of the first area 122_1 may be set as to correspond with the size (i.e., the amount of data) of the setting information to be stored. When the setting information relates to timing between the memory device 100 and the controller as described above, the first area 122_1 may have a size of about 2 Kbytes.

In the memory device 100 according to the exemplary embodiments of the present general inventive concept where the setting information about the controller is stored in the first area 122_1, the input/output device 132 can transmit the setting information stored in the first area 122_1 to the controller when the system is powered up. As described below, the controller may set setting information according to the setting information transmitted from the memory device 100.

The setting information stored in the data storage unit 122 of the memory device 100 according to the exemplary embodiments of the present general inventive concept and transmitted to the controller during the power up of the system may be setting information about the controller optimized to the memory device 100 according to the exemplary embodiments of the present general inventive concept. For example, when the memory device 100 is set to a first CAS latency time, the setting information may be a time to generate a control signal of the controller that is optimized to the first CAS latency time. With regard to the first CAS latency time of the memory device 100, when generating a control signal with a first control time for a first type controller provides optimal performance to the system and generating a control signal with a second control time for a second type controller provides optimal performance to the system, the setting information may have a first control time value with respect to the first type controller and a second control time value with respect to the second type controller.

Since the memory device according to the exemplary embodiments of the present general inventive concept provide setting information about a controller optimized to the memory device, a defect that may occur when the controller wrongly recognizes setting information about the memory device may be minimized and/or prevented, or deterioration of performance may be minimized and/or prevented. That is, according to the memory device according to the exemplary embodiments, an error that may occur when the controller fails to reflect setting information about a newly developed memory device or a newly updated memory device, or when the memory device is set without appropriately reflecting an operation characteristic of the memory device as setting information is differently set by each controller manufacturer, may be minimized and/or prevented. In particular, since the memory device is used in a variety of systems such as a mobile phone, a TV set, a set-top box, a portable media player (PMP), a tablet computer, a laptop and/or a notebook computer, and a navigation system, each chipset maker may not clearly understand optimal characteristic of the memory device. In that case, the structure and operation of the memory device according to the present exemplary embodiments of the present general inventive concept may minimized and/or prevent the above described error.

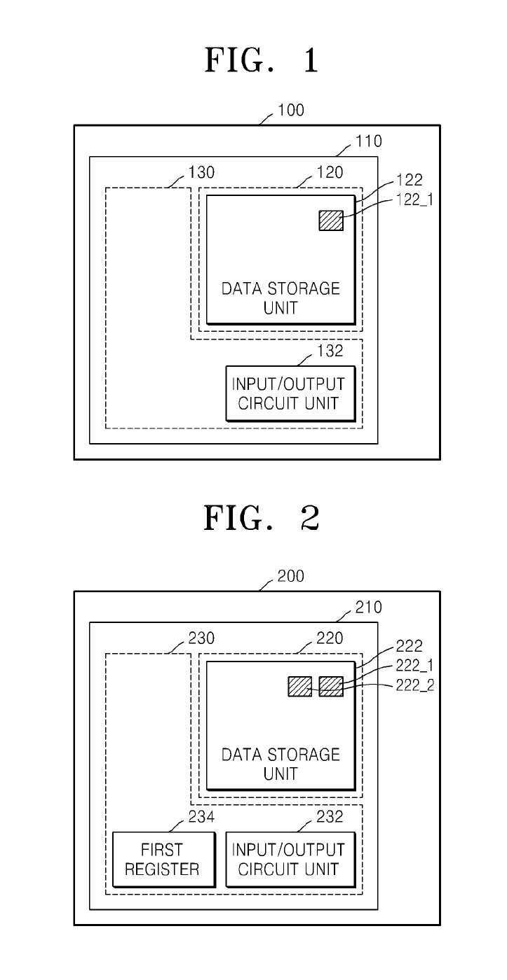

FIG. 2 schematically illustrates a memory device 200 according to exemplary embodiments of the present general inventive concept. Referring to FIG. 2, like the memory device 100 of FIG. 1, the memory device 200 according to exemplary embodiments of the present general inventive concept includes a first memory 210. The first memory 210 includes a core area 220 having a data storage unit 222 and a peripheral circuit area 230 having an input/output circuit unit 232. Similar to the memory device 100 of FIG. 1, setting information may be stored in the data storage unit 222 and, during the power up of the memory device 200, setting information may be transmitted to a corresponding controller.

The first memory 210 of the memory device 200 according to the present exemplary embodiment may be a non-volatile memory or a volatile memory such as a DRAM. When the first memory 210 is a volatile memory such as a DRAM, a first area 222_1 may be a non-volatile memory such as a ROM. The same is a second area 222_2 that is described below.

The memory device 200 of FIG. 2 can include a first register 234 in the peripheral circuit area 230. The first register 234 may be provided to store an operation characteristic of the first memory 210. The operation characteristic of a memory may be a type of a memory or an operation speed of a memory. The operation speed of a memory may be a column address strobe (CAS) latency and a row access strobe (RAS) latency, as described above. The data storage unit 222, like the data storage unit 122 of FIG. 1, may include the first area 222_1 to store setting information of the controller and the second area 222_2 to store setting information of the first register 234. The input/output circuit unit 232 of FIG. 2 may transmit the setting information of the first register 234 together with the setting information of the memory device 200 to the controller during the power up of the memory device 200.

As such, according to the memory device 200 of the exemplary embodiments of the present general inventive concept, during the power up of the system, not only the setting information of the memory device 200 but also the setting information of the first register 234 storing the operation characteristic of the memory device 200 can be transmitted to the controller so that the memory device 200 may be accurately set and controlled.

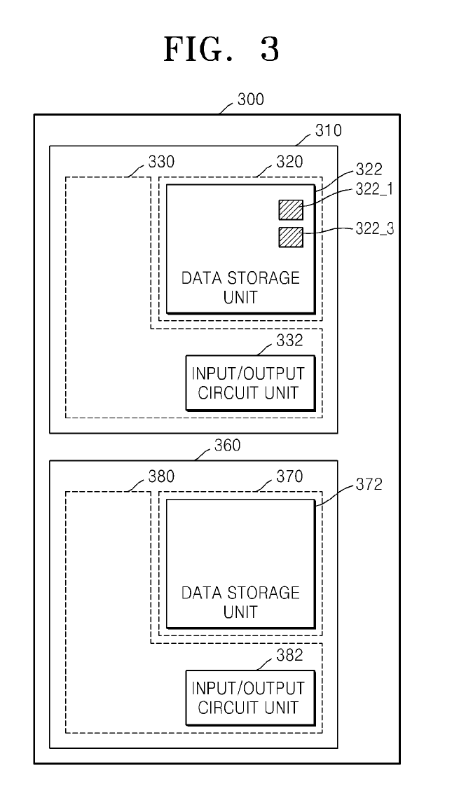

FIG. 3 schematically illustrates a memory device 300 according to exemplary embodiments of the present general inventive concept. Referring to FIG. 3, the memory device 300 according to exemplary embodiments of the present general inventive concept includes a first memory 310 and a second memory 360. The first memory 310 of FIG. 3 may be a ROM. Alternatively, the first memory 310 of FIG. 3 may be a non-volatile memory such as a phase-change memory (PRAM). The second memory 360 may be the same as or different from the first memory 310.

The first memory 310, like the first memory 110 of FIG. 1, can include a core area 320 having a data storage unit 322 and a peripheral circuit area 330 having an input/output circuit unit 332. Like the memory device 100 of FIG. 1, setting information may be stored in the data storage unit 322 and, during the power up of the memory device 300, appropriate setting information may be transmitted to a corresponding controller.

The second memory 360 of the memory device 300 according exemplary embodiments of the present general inventive concept, like first memory 110 of FIG. 1, can include a core area 370 having a data storage unit 372 and a peripheral circuit area 380 having an input/output circuit unit 382. The data storage unit 372 of the second memory 360 does not store setting information of the second memory 360.

Instead, the memory device 300 according to exemplary embodiments of the present general inventive concept may store setting information about the second memory 360 in a second area 322_3 of the data storage unit 322 of the first memory 310. That is, the data storage unit 322 of the first memory 310 of the memory device 300 according to exemplary embodiments of the present general inventive concept includes a first area 322_1 to store setting information about the first memory 310 and the second area 322_3 to store the setting information about the second memory 360.

The input/output circuit unit 332 of the first memory 310 can transmit the setting information about the first memory 310 and the setting information about the second memory 360 to the controller at least during the power up of the memory device 300.

In a multichip package (MCP) such as the memory device 300 of FIG. 3 and a memory device having a plurality of memories that are described below, a setting memory of each of the memories included in the memory device is not self-stored (i.e., the settings of each memory are not individually stored in each respective memory device), whereas the setting information about the memories are all stored in a single memory. As described above, when the size of setting information is not large, an area to store setting information, for example, the first area 322_1 and the second area 322_3, may be included in a single data storage unit. That is, when the size of a setting information is less than or equal to a predetermined amount, the setting information for a plurality of memories of a memory device may be stored in a single data storage unit.

In the memory device 300 according to the exemplary embodiments of the present general inventive concept, since the setting information of the memories are stored in one of the memories, only the memory storing the setting information is accessed during the power up of the memory device 300. That is, not all of the memories are accessed during the power up of the memory device 300, and only the memory device storing the setting information is accessed during power-up of the memory device 300. Thus, the speed of an initialization operation may be increased and/or improved, and power consumption may be reduced (i.e., as fewer memory units may be powered up so as to access the stored setting information).

The memory device 300 of FIG. 3 and other memory devices according to the following exemplary embodiments are illustrated to have only two memories. The setting information about two memories is stored in a first memory. However, the present general inventive concept is not limited thereto. A memory device according to the present general inventive concept may have three or more number of memories. Setting information may be stored, for example, not in the first memory, but in a second memory. Setting information about a plurality of memories may be divided and stored in two or more number of memories, and not only in a single memory.

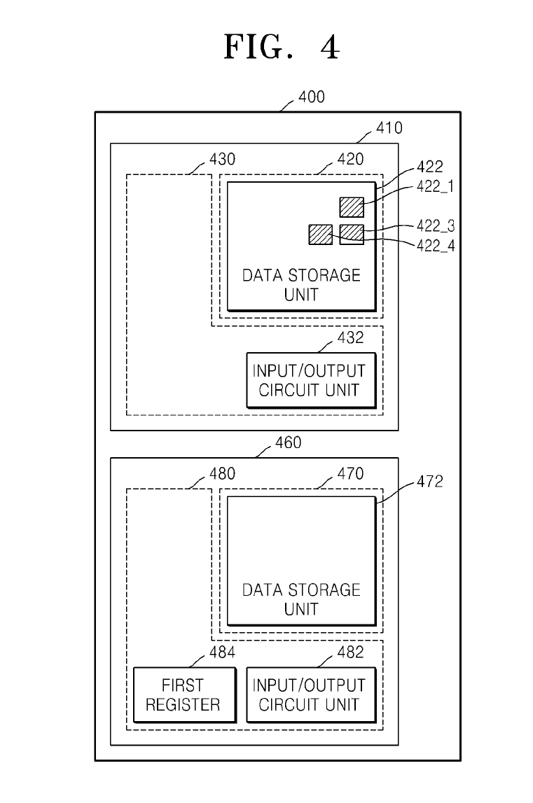

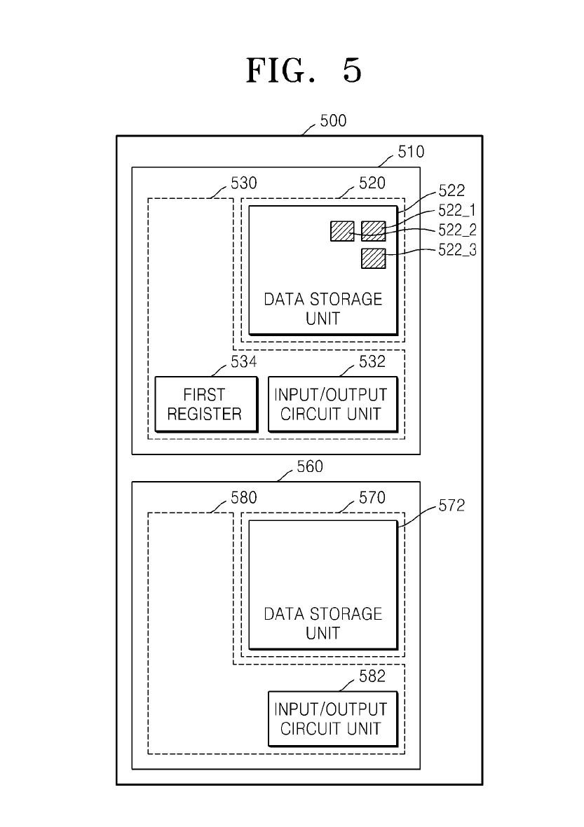

FIG. 4 schematically illustrates a memory device 400 according exemplary embodiments of the present general inventive concept. Referring to FIG. 4, the memory device 400 according to the exemplary embodiments of the present general inventive concept, like the memory device 300 of FIG. 3, can include a first memory 410 and a second memory 460. Likewise, the first memory 410 and the second memory 460 of FIG. 4 may be the same as or different from each other.

The first memory 410 can include a core area 420 having a data storage unit 422 and a peripheral circuit area 430 having an input/output circuit unit 432. Setting information of the first memory 410 can be stored in the data storage unit 422. In contrast, the second memory 460 can include a core area 470 having a data storage unit 472 and a peripheral circuit area 480 having an input/output circuit unit 482. The data storage unit 472 of the second memory 460 may not store setting information of the second memory 460. The setting information about the second memory 460 can be stored in the data storage unit 422 of the first memory 410, as in the exemplary embodiments of the present general inventive concept illustrated in FIG. 3.

Thus, the data storage unit 422 of the first memory 410 of the memory device 400 according to exemplary embodiments of the present general inventive concept includes a first area 422_1 to store the setting information about the first memory 410 and a second area 422_3 to store the setting information about the second memory 460. The input/output circuit unit 432 of the first memory 410 can transmit the setting information about the first memory 410 and the setting information about the second memory 460, to the controller, during the power up of the memory device 400.

The second memory 460 of the memory device 400 of FIG. 4 further includes a first register 484 in the peripheral circuit area 430. The first register 484 may store an operation characteristic of the second memory 460. Since the structure and function of the first register may be easily recognized from the first register 234 of FIG. 2, detailed descriptions thereof will be omitted herein.

The data storage unit 422 of the first memory 410 may further include a third area 422_4 to store setting information of the first register 484. Thus, the input/output circuit unit 432 of the first memory 410 may transmit setting information about a controller that may be optimized to each memory and setting information of the first register 484 to the controller, during the power up of the memory device 400 or the system.

FIG. 5 schematically illustrates a memory device 500 according to exemplary embodiments of the present general inventive concept. Referring to FIG. 5, the memory device 500 according to the exemplary embodiments of the present general inventive concept may be similar to that illustrated in FIG. 4, except for memory device 500 includes a first register 534. In detail, the memory device 500 according to exemplary embodiments of the present general inventive concept includes a first memory 510 and a second memory 560. The first memory 510 and the second memory 560 may be the same as or different from each other.

The first memory 510 can include a core area 520 having a data storage unit 522 and a peripheral circuit area 530 having an input/output circuit unit 532. Setting information of the first memory 510 can be stored in the data storage unit 522. In contrast, the second memory 560 can include a core area 570 having a data storage unit 572 and a peripheral circuit area 580 having an input/output circuit unit 582. The data storage unit 572 of the second memory 560 may not store setting information of the second memory 560. The setting information about the second memory 560 can be stored in the data storage unit 522 of the first memory 510.

Thus, the data storage unit 522 of the first memory 510 of the memory device 500 according to exemplary embodiments of the present general inventive concept includes a first area 522_1 to store the setting information about the first memory 510 and a second area 522_3 to store the setting information about the second memory 560. The data storage unit 522 of the first memory 510 may include a third area 522_2 to store setting information of the first register 534. The input/output circuit unit 532 of the first memory 510 can transmit the setting information about the first memory 510, the setting information about the second memory 560, and the setting information of the first register 534, to the controller, during the power up of the memory device 500.

Unlike the memory device 400 of FIG. 4, the memory device 500 of FIG. 5 can include a first register 534 in the peripheral circuit area 530 of the first memory 510, not in the second memory 560. The first register 534 can store an operation characteristic of the first memory 510. Thus, the input/output circuit unit 532 of the first memory 510 may transmit setting information about a controller that may be optimized to each memory and setting information of the first register 534 to the controller, during the power up of the memory device 500 or the system.

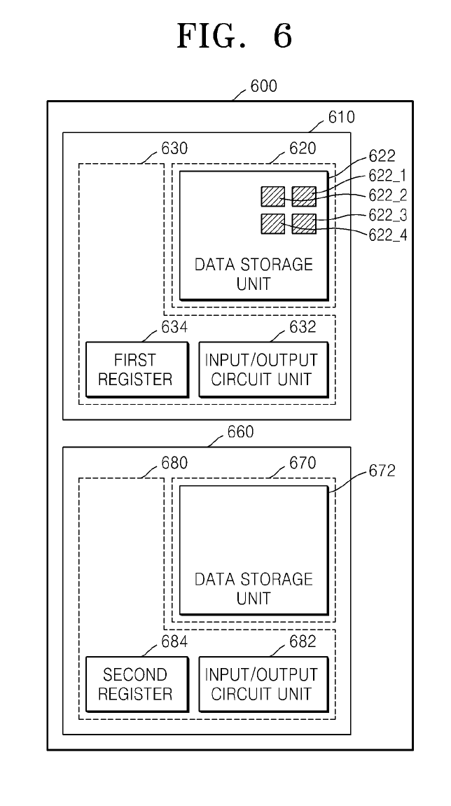

FIG. 6 schematically illustrates a memory device 600 according to exemplary embodiments of the present general inventive concept. Referring to FIG. 6, the memory device 600 according to the exemplary embodiments of the present general inventive concept is similar to the memory device 400 illustrated in FIG. 4, except for the number of registers. That is, the memory device 600 illustrated in FIG. 6 illustrates a first register 634 of first memory 610, and a second register 684 of a second memory 660. In detail, the memory device 600 can include a first memory 610 and a second memory 660. The first memory 610 and the second memory 660 may be the same as or different from each other.

The first memory 610 can include a core area 620 having a data storage unit 622 and a peripheral circuit area 630 having an input/output circuit unit 632. The setting information of the first memory 610 can be stored in the data storage unit 622. In contrast, the second memory 660 can include a core area 670 having a data storage unit 672 and a peripheral circuit area 680 having an input/output circuit unit 682. In exemplary embodiments of the present general inventive concept, the data storage unit 672 of the second memory 660 may not store setting information of the second memory 660. The setting information about the second memory 660 can be stored in the data storage unit 622 of the first memory 610.

Thus, the data storage unit 622 of the first memory 610 of the memory device 600 according to the exemplary embodiments of the present general inventive concept includes a first area 622_1 to store the setting information about the first memory 610 and a second area 622_3 to store the setting information about the second memory 660. The input/output circuit unit 632 of the first memory 610 can transmit the setting information about the first memory 610 and the setting information about the second memory 660, to the controller, during the power up of the memory device 600.

Unlike the memory device 400 of FIG. 4, the memory device 600 of FIG. 6 may include two registers. A first register 634 can be provided in the peripheral circuit area 630 of the first memory 610. A second register 684 can be provided in the peripheral circuit area 680 of the second memory 660. The first register 634 may store an operation characteristic of the first memory 610, whereas the second register 684 may store an operation characteristic of the second memory 660.

The data storage unit 622 of the first memory 610 may include a third area 622_4 to store setting information of the first register 634 and a fourth area 622_2 to store setting information of the second register 684. Thus, the input/output circuit unit 632 of the first memory 610 may transmit the setting information about each memory and each register, to the controller, during the power up of the memory device 600 or the system.

The above-described first through fourth areas (e.g., areas 622_1, 622_2, 622_3, and 622_4) to store the setting information may not be physically separated from an area where user data or other metadata is stored. In the above-described first memories of FIGS. 2 through 6 (e.g., first memory 110 of FIG. 1, first memory 210 of FIG. 2, first memory 310 of FIG. 3, first memory 410 of FIG. 4, first memory 510 of FIG. 5, and first memory 610 of FIG. 6), a plurality of setting information are stored in other areas that are separated from one another. However, the exemplary embodiments of the present general inventive concept are not limited thereto. The first through fourth areas may be one area that is not physically separated. In this case, in order to identify various objects, that is, the first memory, the second memory, the first register, or the second register, of setting information to be stored in one area, each setting information may be stored with an identifier for a corresponding object.

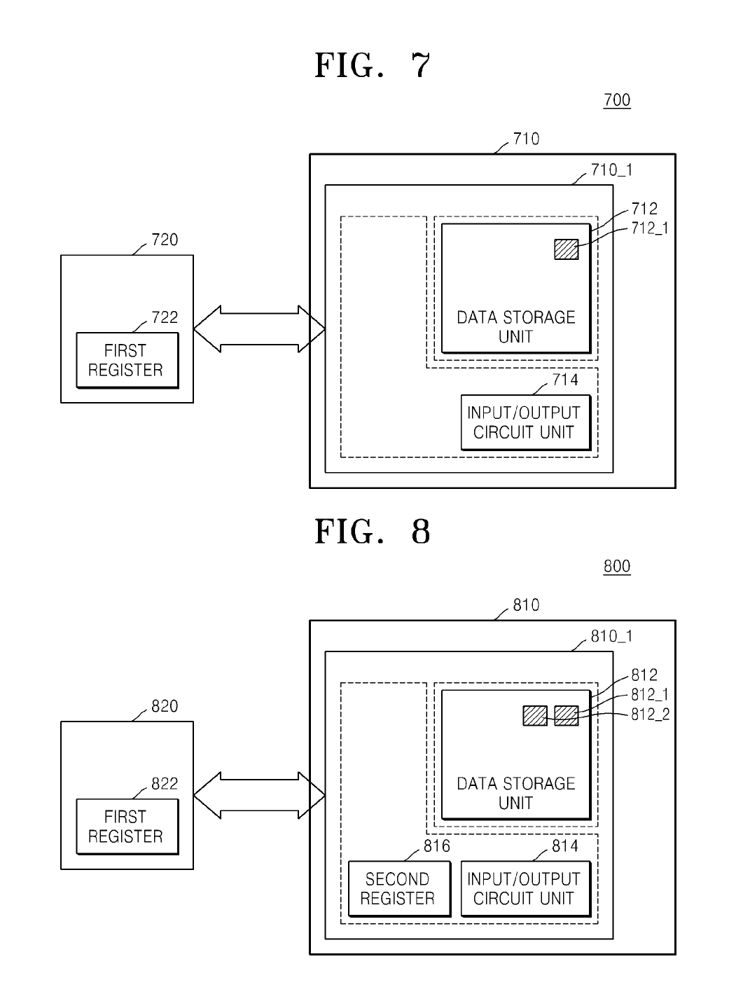

FIG. 7 illustrates a memory system 700 according to exemplary embodiments of the present general inventive concept. Referring to FIG. 7, the memory system 700 includes a memory device 710 and a memory controller 720. The memory device 710, which may be similar to the first memory 110 illustrated in FIG. 1, can include a first memory 710_1 having a data storage unit 712 and an input/output circuit unit 714. The memory controller 720 may transmit an address and a command to store data in the memory device 710 or read data stored in the memory device 710, to the memory device 710. The memory device 710, in response to a received command, can store data in an area corresponding to a received address or output data from the received address.

In order for the memory controller 720 to accurately control the memory device 710, as described above, the memory controller 720 may be set to setting information optimized to an operation characteristic of the memory device 710. The memory system 700 according to exemplary embodiments of the present general inventive concept, like the memory device 100 of FIG. 1, setting information about the memory controller 720 optimized to an operation characteristic of the memory device 710 can be stored in a first area 712_1 and the setting information stored in the first area 712_1 can be transmitted to the memory controller 720 during the power up of the memory system 700.

The setting information transmitted from the memory device 710 to the memory controller 720 can be stored in a first register 722 included in the memory controller 720. The memory controller 720 is set to the setting information stored in the first register 722 regarding a control operation about the memory device 710.

FIG. 8 illustrates a memory system 800 according to exemplary embodiments of the present general inventive concept. Referring to FIG. 8, the memory system 800 can include a memory device 810 and a memory controller 820. The memory device 810, as illustrated in FIG. 2, can include a first memory 810_1 including a data storage unit 812, an input/output circuit unit 814, and a second register 816. The second register 816 may store an operation characteristic of the first memory 810_1.

The memory system 800 according to exemplary embodiments of the present general inventive concept, like the memory device 200 of FIG. 2, can store setting information about the memory controller 820 optimized to an operation characteristic of the memory device 810 in a first area 812_1 and setting information of the second register 816 in a second area 812_2. During the power up of the memory system 800, the setting information stored in the first and second areas 812_1 and 812_2 can be transmitted to the memory controller 820.

The setting information transmitted from the memory device 810 to the memory controller 820 can be stored in the first register 822 included in the memory controller 820. The memory controller 820 can be set to the setting information stored in the first register 822 regarding a control operation of the memory device 810.

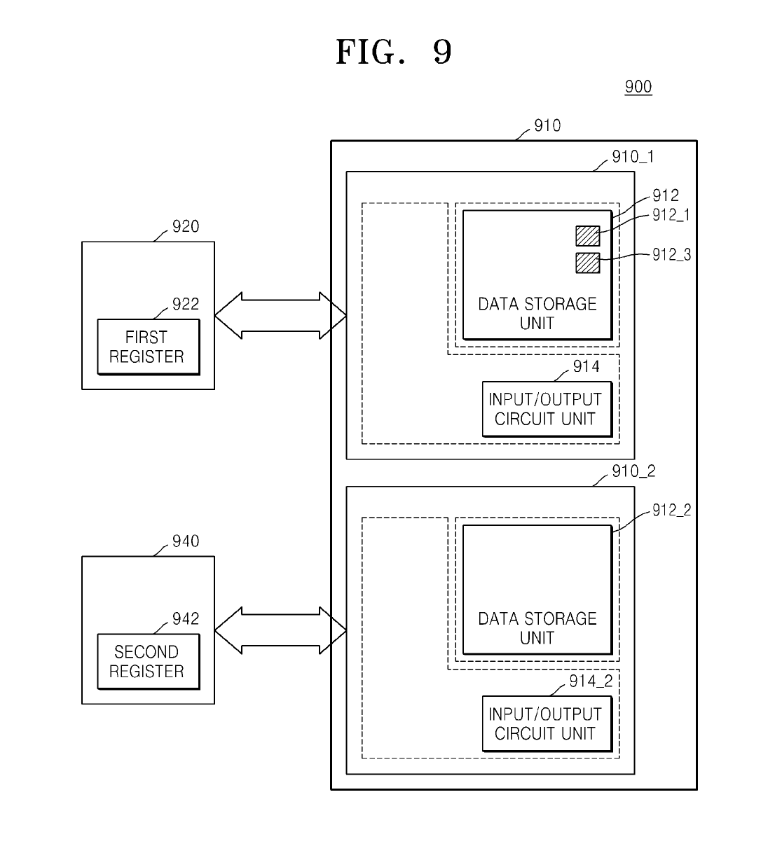

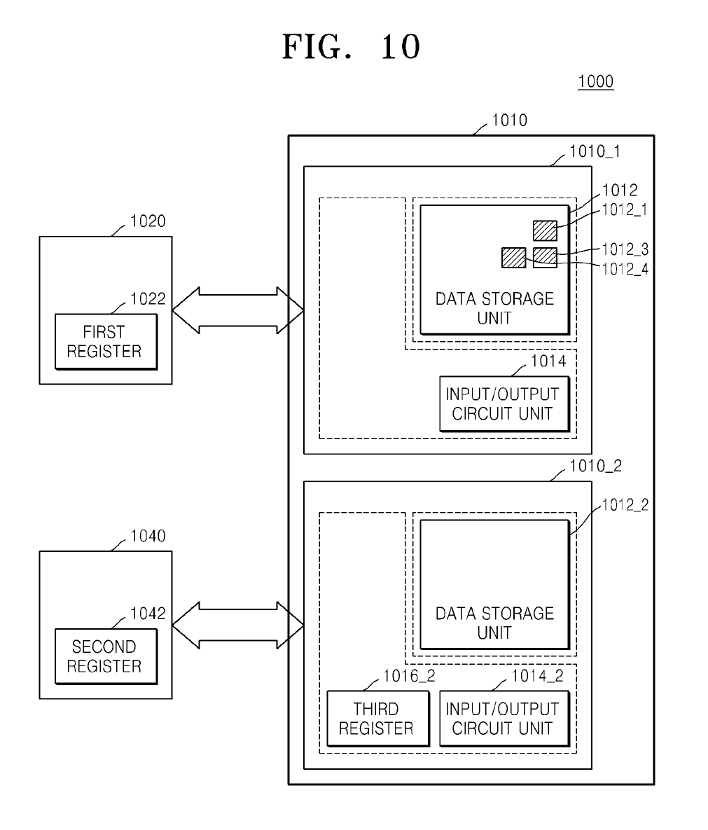

FIG. 9 illustrates a memory system 900 according to exemplary embodiments of the present general inventive concept. Referring to FIG. 9, the memory system 900 can include a memory device 910, a first memory controller 920, and a second memory controller 940. The memory device 910 can include a first memory 910_1 controlled by the first memory controller 920 and a second memory 910_2 controlled by the second memory controller 940. The first and second memories 910_1 and 910_2 both may be non-volatile memories. The first memory 910_1 can include a data storage unit 912 and an input/output circuit unit 914. The second memory 910_2 can include a data storage unit 912_2 and an input/output circuit unit 914_2.

In the memory system 900 according to exemplary embodiments of the present general inventive concept, like the memory device 300 of FIG. 3, setting information about the controller may be stored in a single memory. In FIG. 9, setting information about the first memory controller 920 can be stored in a first area 912_1 of the first memory 910_1 and setting information about the second memory controller 940 can be stored in a second area 912_3 of the first memory 910_1. As described above, setting information to realize optimal performance for each controller may vary according to the controller.

The setting information stored in the first area 912_1 can be transmitted to the first memory controller 920 and the setting information stored in the second area 912_3 can be transmitted to the second memory controller 940, during the power up of the memory system 900. The setting information transmitted to the first memory controller 920 can be stored in a first register 922 included in the first memory controller 920. Likewise, the setting information transmitted to the second memory controller 940 can be stored in a second register 942 included in the second memory controller 940.

The first memory controller 920 can be set to the setting information stored in the first register 922 regarding a control operation of the first memory 910_1. Likewise, the second memory controller 940 can be set to the setting information stored in the second register 942 regarding a control operation of the second memory 910_2.

FIG. 10 illustrates a memory system 1000 according to exemplary embodiments of the present general inventive concept. Referring to FIG. 10, the memory system 1000 can include a memory device 1010 like the memory device 400 of FIG. 4, a first memory controller 1020, and a second memory controller 1040. The memory device 1010 can include a first memory 1010_1 controlled by the first memory controller 1020 and a second memory 1010_2 controlled by the second memory controller 1040. The first memory 1010_1 may be a non-volatile memory, whereas the second memory 1010_2 may be a volatile memory such as a DRAM.

The first memory 1010_1 can include a data storage unit 1012 and an input/output circuit unit 1014. The second memory 1010_2 can include a data storage unit 1012_2 and an input/output circuit unit 1014_2, as well as a third register 1016_2 to store an operation characteristic of the second memory 1010_2.

In FIG. 10, setting information about the first memory controller 1020 can be stored in a first area 1012_1 of the data storage unit 1012 of the first memory 1010_1, setting information about the second memory controller 1040 can be stored in a second area 1012_3 of the data storage unit 1012 of the first memory 1010_1, and setting information about the third register 1016_2 can be stored in a third area 1012_4 of the first memory 1010_1. The setting information stored in the first area 1012_1 can be transmitted to the first memory controller 1020 and the setting information stored in the second and third areas 1012_3 and 1012_4 can be transmitted to the second memory controller 1040, during the power up of the memory system 1000. The setting information transmitted to the first memory controller 1020 can be stored in a first register 1022 included in the first memory controller 1020. Likewise, the setting information transmitted to the second memory controller 1040 can be stored in a second register 1042 included in the second memory controller 1040.

The first memory controller 1020 can be set to the setting information stored in the first register 1022 regarding a control operation of the first memory 1010_1. Likewise, the second memory controller 1040 can be set to the setting information stored in the second register 1042 regarding a control operation of the second memory 1010_2.

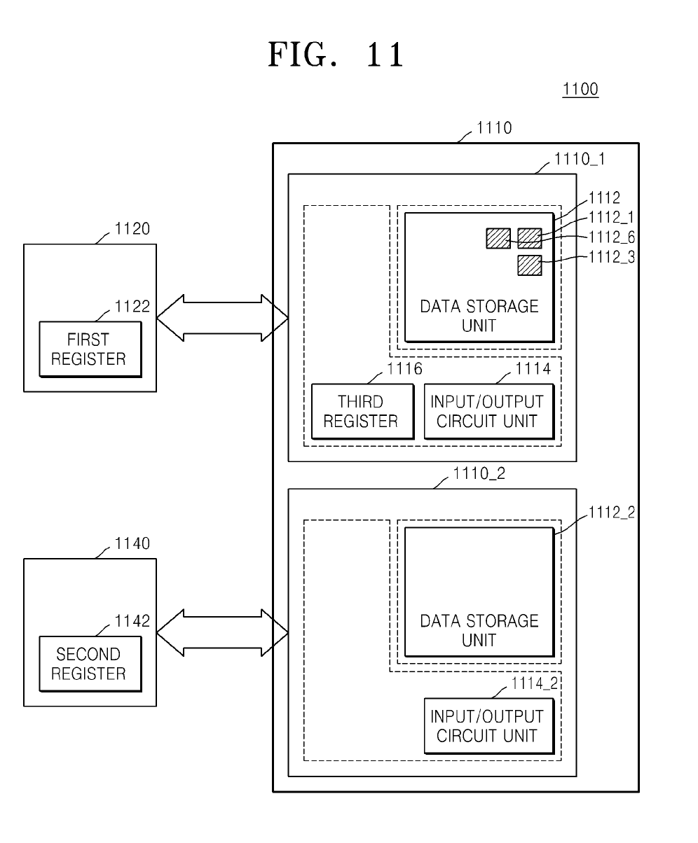

FIG. 11 illustrates a memory system 1100 according to exemplary embodiments of the present general inventive concept. Referring to FIG. 11, the memory system 1100 can include a memory device 1110 like the memory device 500 of FIG. 5, a first memory controller 1120, and a second memory controller 1140. The memory device 1110 can include a first memory 1110_1 controlled by the first memory controller 1120 and a second memory 1110_2 controlled by the second memory controller 1140. The first memory 1110_1 may be a non-volatile memory, whereas the second memory 1110_2 may be a volatile memory such as a DRAM.

The first memory 1110_1 can include a data storage unit 1112, an input/output circuit unit 1114, and a third register 1116. The second memory 1110_2 can include a data storage unit 1112_2 and an input/output circuit unit 1114_2.

Setting information about the first memory controller 1120 can be stored in a first area 1112_1 of the data storage unit 1112 of the first memory 1110_1, setting information about the second memory controller 1010 can be stored in a second area 1112_3 of the data storage unit 1112 of the first memory 1110_1, and setting information about the third register 1116 can be stored in a third area 1112_6 of the first memory 1110_1. The setting information stored in the first area 1112_1 can be transmitted to the first memory controller 1120 and the setting information stored in the second and third areas 1112_3 and 1112_6 can be transmitted to the second memory controller 1140, during the power up of the memory system 1100.

Since the structure and function of the memory system 1110 of FIG. 11 are substantially the same as those of the memory system 1000 of FIG. 10, except that the third register 1116 is provided in the first memory 1110_1 and thus setting information about the third register 1116 is transmitted to the first memory controller 1120, detailed descriptions thereof will be omitted herein.

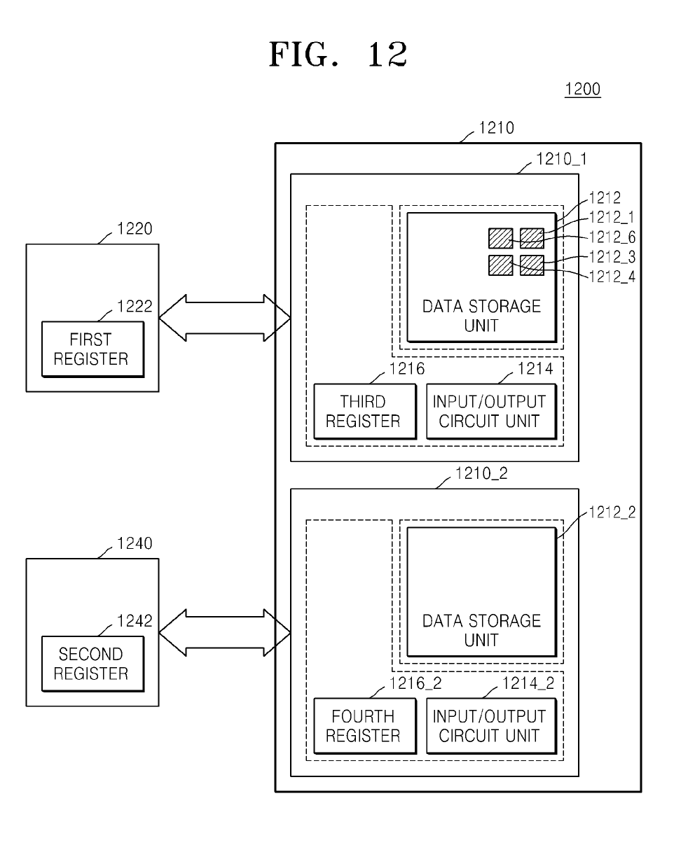

FIG. 12 illustrates a memory system 1200 according to exemplary embodiments of the present general inventive concept. Referring to FIG. 12, the memory system 1200 can include a memory device 1210 like the memory device 600 of FIG. 6, a first memory controller 1220, and a second memory controller 1240. The memory device 1210 can include a first memory 1210_1 controlled by the first memory controller 1220 and a second memory 1210_2 controlled by the second memory controller 1240. The first and second memories 1210_1 and 1210_2 both may be volatile memories such as DRAMs.

The first memory 1210_1 can include a data storage unit 1212, an input/output circuit unit 1214, and a third register 1216 to store an operation characteristic of the first memory 1210_1. The second memory 1210_2 can include a data storage unit 1212_2, an input/output circuit unit 1214_2, and a fourth register 1216_2 to store an operation characteristic of the second memory 1210_2.

In FIG. 12, setting information about the first memory controller 1220 can be stored in a first area 1212_1 of the data storage unit 1212 of the first memory 1210_1, setting information about the second memory controller 1240 can be stored in a second area 1212_3 of the data storage unit 1212 of the first memory 1210_1, setting information about the third register 1216 can be stored in a third area 1212_6 of the first memory 1210_1 and setting information about the fourth register 1216_2 can be stored in a fourth area 1212_4 of the first memory 1210_1.

The setting information stored in the first and third areas 1212_1 and 1212_6 can be transmitted to the first memory controller 1220 and the setting information stored in the second and fourth areas 1212_3 and 1212_4 can be transmitted to the second memory controller 1240, during the power up of the memory system 1200. The setting information transmitted to the first memory controller 1220 can be stored in a first register 1222 included in the first memory controller 1220. Likewise, the setting information transmitted to the second memory controller 1240 can be stored in a second register 1242 included in the second memory controller 1240.

The first memory controller 1220 can be set to the setting information stored in the first register 1222 regarding a control operation of the first memory 1210_1. Likewise, the second memory controller 1240 can be set to the setting information stored in the second register 1242 regarding a control operation of the second memory 1210_2.

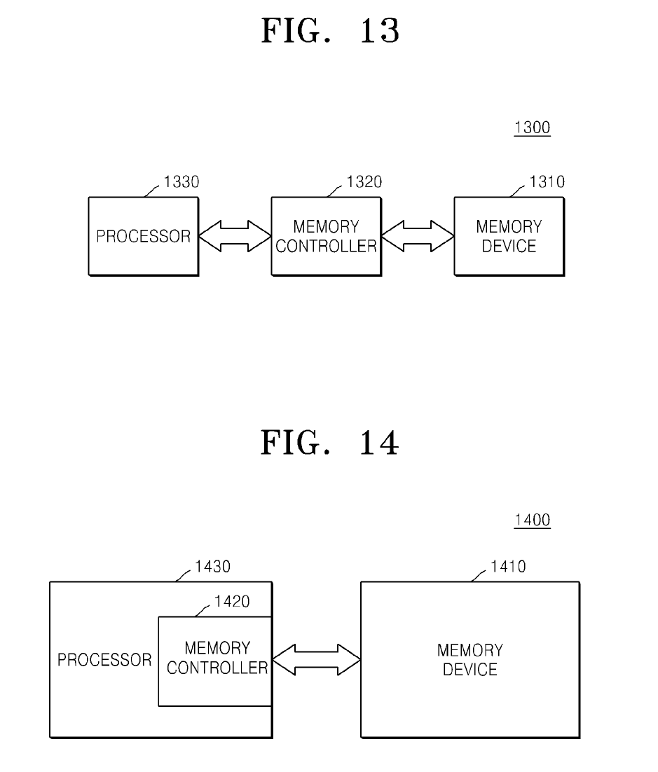

FIGS. 13 and 14 schematically illustrate computer systems 1300 and 1400 according to exemplary embodiments of the present general inventive concept. Referring to FIGS. 13 and 14 together, the computer systems 1300 and 1400 respectively include processors 1330 and 1430, memory devices 1310 and 1410 like the memory devices of FIGS. 1-12, and memory controllers 1320 and 1420 like the memory controllers of FIGS. 7-12. There may be a variety of types of the memory controllers 1320 and 1420. In the computer system 1300 of FIG. 13, the memory controller 1320 can be separated from the processor 1330. In contrast, in the computer system 1400 of FIG. 14, the memory controller 1420 can be included in the processor 1430.

While the present general inventive concept has been particularly illustrated and described with reference to preferred embodiments using specific terminologies, the embodiments and terminologies should be considered in descriptive sense only and not for purposes of limitation. Therefore, it will be understood by those of ordinary skill in the art that various changes in form and details may be made therein without departing from the spirit and scope of the present general inventive concept as defined by the following claims.

What is claimed is:

1. A memory device having at least one memory, the memory device comprising:
a first memory including:
a core area having a data storage unit that is non-volatile to store setting information about a memory controller corresponding to the first memory; and
a peripheral circuit area having an input/output circuit.

2. The memory device of claim 1, wherein the first memory further comprises:
a first register to set an operation characteristic,
wherein the data storage unit of the first memory stores setting information of the first register.

3. The memory device of claim 1, further comprising:
a second memory including:
a core area having a data storage unit; and
a peripheral circuit area having an input/output circuit,
wherein the data storage unit of the first memory stores setting information about a memory controller corresponding to the second memory.

4. The memory device of claim 3, wherein the second memory further comprises:
a first register to set an operation characteristic,
wherein the data storage unit of the first memory stores setting information of the first register.

5. The memory device of claim 3, wherein the first memory further comprises:
a first register to set an operation characteristic,
wherein the data storage unit of the first memory stores setting information of the first register.

6. The memory device of claim 5, wherein the second memory further comprises:
a second register to set an operation characteristic,
wherein the data storage unit of the first memory further stores setting information of the second register.

7. The memory device of claim 6, being embodied by a multichip package (MCP).

8. The memory device of claim 7, wherein the first memory is a read only memory (ROM).

9. A memory system comprising:
a memory device including:
at least one memory; and
at least one memory controller having a register, the at least one memory controller to control a corresponding memory according to a setting state of the register;
a first memory including:
a core area having a data storage unit that is non-volatile to store setting information about the register of a memory controller corresponding to the first memory; and
a peripheral circuit area having an input/output circuit.

10. The memory system of claim 9, wherein the first memory further comprises:
a first register to set an operation characteristic,
wherein the data storage unit of the first memory stores setting information of the first register.

11. The memory system of claim 9, wherein the memory device further comprises:
a second memory, including:
a core area including a data storage unit; and
a peripheral circuit area including an input/output circuit,
wherein the data storage unit of the first memory stores setting information about a memory controller corresponding to the second memory.

12. The memory system of claim 11, wherein the second memory further comprises:
a first register to set an operation characteristic,
wherein the data storage unit of the first memory stores setting information of the first register.

13. The memory system of claim 11, wherein the first memory further comprises:
a first register to set an operation characteristic,
wherein the data storage unit of the first memory stores setting information of the first register.

14. The memory system of claim 13, wherein the second memory further comprises:
a second register to set an operation characteristic,
wherein the data storage unit of the first memory to store setting information of the second register.

15. The memory system of claim 14, wherein the memory device is embodied by a multichip package (MCP).

16. A memory system, comprising:
a memory device having a first memory, including:
a core area having a data storage unit that is non-volatile to store setting information about a memory controller corresponding to the first memory; and
a peripheral circuit area having an input/output circuit; and
a memory controller communicatively coupled to the memory device to control at least one operation of the memory device.

17. The memory system of claim 16, wherein the data storage unit includes a first area to store setting information of the memory controller, the setting information to be transmitted to the memory controller during power-up of the memory system.

18. The memory system of claim 17, wherein the memory controller includes a first register to the setting information of the memory controller that is transmitted to the first area of the data storage unit.

19. The memory system of claim 16, wherein the memory device further comprises:
a second register of the first memory to store an operation characteristic of the first memory.

20. The memory system of claim 19, further comprising:
a second area of the data storage unit to store setting information of the second register.
